(19) United States
(12) Patent Application Publication
(10) Pub. No.: US 2024/0119349 A1
(43) Pub. Date: Apr. 11, 2024

(54) METHOD AND SYSTEM FOR OPTIMIZING TRAINING OF A MACHINE LEARNING MODEL

(71) Applicant: L&T TECHNOLOGY SERVICES LIMITED, Chennai (IN)

(72) Inventors: Sukant DEBNATH, Ahmedabad (IN); Mridul BALARAMAN, Bangalore (IN); Ishita DAS, Kolkata (IN); Madhusudan SINGH, Bangalore (IN); Guneet Singh TANDON, New Delhi (IN)

(21) Appl. No.: 18/011,113

(22) PCT Filed: Mar. 15, 2022
(86) PCT No.: PCT/IB2022/052325

§ 371 Date: Dec. 16, 2022

(30) Foreign Application Priority Data
Jun. 25, 2021 (IN) 202141028705

(51) Int. Cl. G06N 20/00

(52) U.S. Cl. CPC G06N 20/00

(57) ABSTRACT

A method of optimizing training of a machine learning model is disclosed. The method may include receiving an input training data using an optimization device. The input training data may include a plurality of training data samples. Further, a set of relevant training data samples from the input training data may be identified. The method may use the optimization device to select a suitable type and configuration of a machine learning model from a plurality of types and configurations of machine learning models for processing the set of relevant training data samples. Furthermore, the method may validate the set of relevant training data samples.

### TECHNICAL FIELD

This disclosure relates generally to machine learning, and more particularly to generating a training dataset for training machine learning based model.

### BACKGROUND

A machine learning model may be trained before being deployed and during execution for solving a problem, for example by performing a classification. The model may be trained using training datasets where strength of the model is based on quality and size of the training datasets. Huge size of the training datasets may lead to consumption of significant amount of computing resources, computing effort and storage resources. In addition, in case the available training data has too low a dimension and too small a data volume it may affect training accuracy of the machine learning model.

There is therefore a need in the art to provide a method and system for training the machine learning model using training data that overcomes the above problems or at least partially solves the above problems.

### SUMMARY OF THE INVENTION

A method of optimizing training of a machine learning model is disclosed. The method may include receiving an input training data using an optimization device. The input training data may include a plurality of training data samples. Further, a set of relevant training data samples from the input training data may be identified. The method may use the optimization device to select a suitable type and configuration of a machine learning model from a plurality of types and configurations of machine learning models for processing the set of relevant training data samples. Furthermore, the method may validate the set of relevant training data samples.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a high level block diagram of a system for optimizing training of a machine learning model, in accordance with an embodiment of the present disclosure.

FIG. 2 illustrates a block diagram of the system for optimizing training of a machine learning model, in accordance with another embodiment of the present disclosure.

FIG. 3 illustrates a block diagram of the system for optimizing training of a machine learning model, in accordance with yet another embodiment of the present disclosure.

FIGS. 4A-4B illustrate a block diagram of the system for optimizing training of a machine learning model, in accordance with yet another embodiment of the present disclosure.

FIG. 5 is a flowchart of a method of optimizing training of a machine learning model, in accordance with an embodiment.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

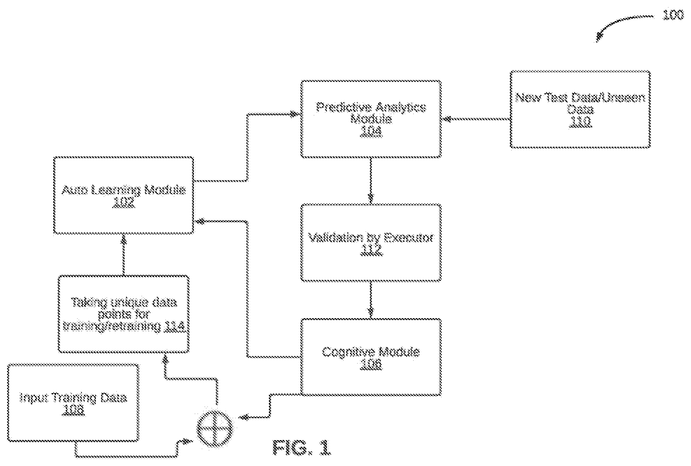

Referring to FIG. 1, a high level block diagram of a system 100 for optimizing training of a machine learning model is illustrated, in accordance with an embodiment of the present disclosure. Further, the system 100 may include an auto-learning module 102, a predictive analytics module 104, a cognitive module 106, an input training data block 108, a new test data and unseen data block 110, a data points block 114, and an executor validation block 112.

The input training data block 108 may provide a plurality of data samples for training the machine learning model. Each of the plurality of data samples may include a plurality of features. In an initial instance when a cognitive cycle is not present then the input training data from the input training data block 108 may be fed directly to the auto-learning module 102.

However, if the cognitive cycle is already available then unique data points for training or re-training of the machine learning model may be determined and fed from data points block 114 to the auto-learning module 102 along with the input training data 108. For instance, when the machine learning model has been trained as per a test model and a validation has been done based on the training then a feedback may be received based on the validation data from cognitive module 106. The feedback received may be used to retrain the input training data 108. In this case this output may be merged with the training data and unique points out of these two data may be determined by the data points block 114 and fed that into the machine learning model.

The auto-learning module 102 may be equipped to identify correct and crucial samples from the received plurality of samples. By identifying the correct and crucial samples, the auto learning module 102 may reduce a count of the number of data samples to be used for training the model. This may be done by capturing variability in the received plurality of data samples and may facilitate the machine learning model to learn right data with faster and better accuracy.

The predictive analytics module 104 may receive input from the auto-learning module 102 and may create best models from the selected data samples by tuning and cleaning all available possible parameters. Further, the predictive analytics module 104 may receive a new test dataset from the new test data and unseen data block 110. Additionally, the predictive analytics block 104 may identify a best model by tuning and cleaning the dataset through multiple iterations and obtaining right set of features for training the machine learning model.

Once the output received from the predictive analytics module 104 is validated at the executor validation block 112, the cognitive module 106 may receive an input from the predictive analytics module 104. To create a robust machine learning model, when an additional set of data is added, the cognitive module 106 may validate the actual record with the predicted ones to determine what all records have been incorrectly classified. Further, the cognitive module 106 may identify misclassification of the datasets and cases where prediction is incorrect and cases where prediction is correct, but confidence score is less.

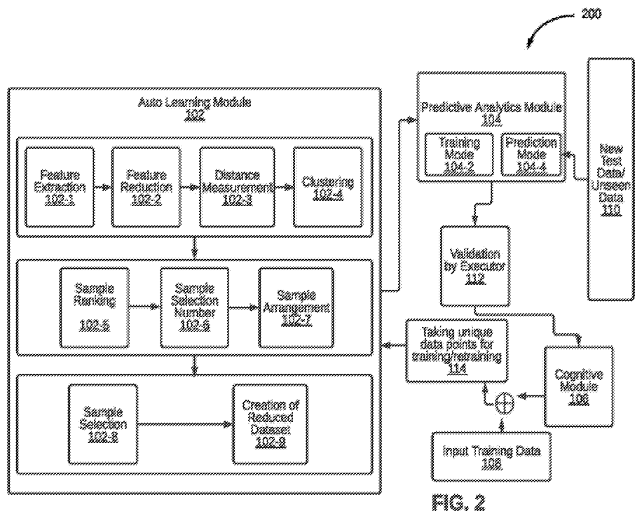

Referring now to FIG. 2, a block diagram of a system 200 (corresponding to system 100) for optimizing training of a machine learning model is illustrated, in accordance with another embodiment of the present disclosure. The system 200 may include an auto-learning module for identifying a set of relevant training data samples from input training data. Identification of the set of relevant training data samples from the input training data may be performed using an auto-learning module 102. The auto-learning module 102 may enable reducing a set of data samples to be used for training a machine learning model thereby avoiding the system 100 to process all the available set of data samples. Further, the auto-learning module 102 may determine a right set of features for training the machine learning model.

In an embodiment, the auto-learning module 102 may be used to determine variability in the dataset. For proper training of the machine learning model, it may be crucial to determine variability in data samples of the dataset. The auto-learning module 102 may identify reasonable features from the dataset to train the machine learning model. As may be appreciated, when the data is mostly similar training of the machine learning model may not be efficient.

The auto learning module 102 may include, for example, a feature extraction block 102-1. Typically, datasets having multiple features may be evaluated by the machine learning model and when a number of features becomes similar to a number of observations stored in a dataset then this may lead the machine learning model to suffer from a problem of overfitting. To avoid this type of problem, a feature extraction block 102-1 may be used. The feature extraction block 102-1 may include using either of regularization or dimensionality reduction techniques. Multiple techniques used by the feature extraction block 102-1 are, for example, Principal Component Analysis (PCA), Independent Component Analysis (ICA), linear discriminant analysis (LDA), Locally Linear Embedding (LLE), t-distributed stochastic neighbor embedding (t-SNE) and Auto Encoders (AE).

In an embodiment, the feature extraction block 102-1 may extract the dataset based on features that are relevant to be learned by the machine learning model. Some of features that are irrelevant for the dataset may be extracted and data based on those irrelevant datasets may be discarded. Additionally, the relevant features may be selected from the selected dataset by performing a clustering mechanism.

A feature reduction block 102-2, may reduce dimensionality of features from the selected datasets. Process of reducing number of features in a resource heavy computation without losing important information is a crucial task. Further, reducing the number of features may imply minimizing a number of variables thereby making the system 100 work faster. Feature reduction mechanism by the feature reduction block 102-2 may be include using techniques such as discriminant analysis, autoencoders, non-negative matrix factorization, and principal component analysis.

A distance measurement block 102-3 may find similarity among data points when one or more clusters are to be determined from the selected dataset. The distance measurement block 102-3 may measure a relative difference between two datasets in a problem domain. Typically, a Hamming Distance, a Euclidean distance, a Manhattan distance, and a Makowski distance may be used for measuring distance by the distance measurement block 102-3. Further, a set of machine learning algorithms that use distance measurement at their core are, for example, K-Nearest Neighbors algorithm, Learning Vector Quantization (LVQ) algorithm, Self-Organizing Map (SOM) algorithm, and K-Means Clustering algorithm.

A clustering block 102-4 may divide the determined data points into a number of groups such that the determined data points in same groups are more similar to other data points in the same group and dissimilar to the data points in other groups. The clustering block 102-4 may determine a collection of objects on basis of similarity and dissimilarity between them using clustering methods, for example, Density-Based Methods, Hierarchical Based Methods, Partitioning Methods, and Grid-based Methods. Also, the clustering algorithms may be, for example, Euclidean distance, Cosine similarity, Manhattan distance, K-means clustering algorithm, Mean-Shift Clustering, Density-Based Spatial Clustering of Applications with Noise (DBSCAN), and Expectation-Maximization (EM) Clustering using Gaussian Mixture Models (GMM).

Clusters determined by the clustering block 102-4 may be received as input at a sample ranking block 102-5. In an embodiment, when the machine learning model is untrained all the clusters may be ranked equally. Further, when a cluster is to be used to understand that which of the data sample is to be selected, then a minimum number of samples that are required to represent the cluster may be estimated. For example, when there are 10 data samples in a cluster all the 10 samples may not be required, and only 4-5 samples which have a maximum distance between them (i.e., have most variability) may be selected. In case the machine learning model is already trained (i.e., a pretrained model is available) then the pretrained model may be used to find an average for each of the cluster.

A sample selection number block 102-6, and a sample arrangement block 102-7 may select and arrange the determined set of ranked data samples.

Further, a sample selection block 102-8 may select a sample from the data samples and determine a dataset from the selected sample using a creation reduced dataset block 102-9.

The predictive analytics module 104 may have two modes of execution, for example, a training mode 104-2 and a prediction mode 104-4. The training mode 104-2 may train a fresh model on new training data. The prediction mode 104-4 may predict on new test data once the training mode is trained. The new test data and unseen data block 110 may be inputted to the predictive analytics module 104.

Upon validation by the executor 112, the output from the predictive analytics blocks may be sent as input to the cognitive module 106. The cognitive module 106 may remain inactive till the validator do not execute any new records from the trained predicted model. Output from the cognitive model may be combined with the input training data 108 and then unique data points as determined from the cognitive module 106 and the input training data may be fed as into to the auto learning model 102.

Byway of an example, when there are 10,000 records in a particular document that are provided as input, 8000 records may be used for training purposes and 2000 records may be used for testing purposes. The data may be split for testing of the particular model. Further, during training of the machine learning model, a test may be done using the available records. During testing, it may be noted that some of the data is new (i.e., not present in training documents) and in other cases there may be unseen data (i.e., new data, not available in input training data). Both of the new data and the unseen data may be validated before being used.

Upon validation by the executor, the cognitive module 106 may determine and derive instances of the data for which a prediction has not been done correctly. The determined and derived instances of the data may be merged with the input training data and only unique data points may be extracted from these to send back to the machine learning model training and retraining of the machine learning model.

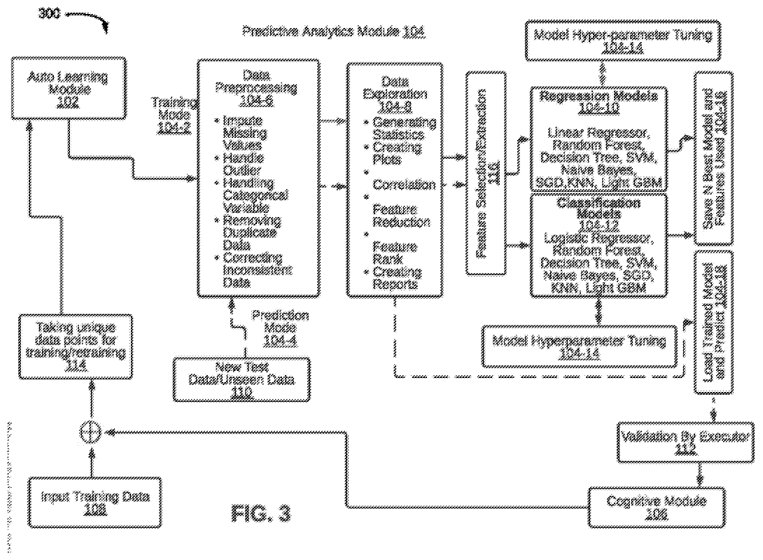

Referring now to FIG. 3, a block diagram of a system 300 (corresponding to system 100) for optimizing training of a machine learning model is illustrated, in accordance with yet another embodiment of the present disclosure. The system 300 may include a predictive module 104 for selecting a suitable type and configuration of a machine learning model is illustrated, in accordance with some embodiments of the present disclosure. The predictive analytics module 104 may involve performing multiple permutations and computations on the data and generating reports based on the data which may be understood by the machine learning model.

The predictive analytics module 104 may include a data processing block 104-6, a data exploration block 104-8, a feature selection/extraction block 116, a set of regression models 104-10, a set of classification models 104-12, and a model hyper-parameter tuning block 104-14.

The data processing block 104-6 may pre-process set of relevant training data samples received from the auto-learning module 102. The pre-processing may be done by cleaning the data samples before giving the data samples to the machine learning model as multiple variations of data and irrelevant data may be present. The pre-processing may be done by, for example, imputing missing values, removing outlier values, handling categorical variable values, removing duplicate data samples, and correcting inconsistent data.

Typically, the datasets to be used by the machine learning model may have missing values and may be a reason of concern to be used for training the machine learning models. Hence there is a requirement for eliminating missing values from the dataset. The missing values for each entry in an input dataset may be replaced prior to modeling a prediction task using the imputing missing values processing. Further, when the dataset contains extreme values that are outside a range of what is expected and unlike other data then that dataset may be called outliers and the machine learning model may be improved by understanding and removing the outlier values.

Categorical data in the dataset may be data that takes a limited number of possible values. Additionally, the data in a category need not be numerical, and it may also be textual as well. For training the machine learning model, a kind of mathematical model that need numbers to work with may be required. For this the categorical data may be pre-processed before feeding to the machine learning model. Further, duplicate data samples may be removed from the obtained data samples for inputting unique data samples to the machine learning model. Here inconsistent data may be eliminated from the dataset before feeding the dataset to the machine learning model.

The data exploration block 104-8 may include performing data analysis on the received dataset for training the data model. Data analysts may use data visualization and statistical techniques to describe dataset characterizations, such as data type, counts, min, max, average values for each features, to better understand the data. The data exploration may be performed using mechanisms, for example, generating statistics, creating plots, correlation, feature reduction, feature rank, and creating reports.

Output from the data exploration block 104-8 may be sent as input to the feature selection/extraction block 116. For example, when there are ten features for a particular training data, not all of the features may be required for training the machine learning model. Based on the data exploration block 104-8, the machine learning model may determine which of the data is critical and be used for training the machine learning model. When the data has more than one relevant feature, the set of relevant features may be reduced down to a lower dimension. In addition, exact set of features may be determined that may be lower in number and may be sent to the regression model 104-10 and the classification model 104-12. The features extracted may be used by the prediction mode 104-4.

Based on an input received from the data analyst, the system 100 may switch between using either of the set of regression model 104-10 or the set of classification models 104-12 for further processing and training of the dataset. The dataset may be fitted and checked against each of a model of the set of regression model 104-10 and a mechanism of the set of classification models 104-12. The dataset may be varied by performing a permutation and computation on the dataset for determining which of a form of the dataset is to be used for training the machine learning model.

The set of regression model 104-10 may use models such as, for example, a Linear Regressor model, a Random Forest model, a Decision Tree model, a Support Vector Machine (SVM) model, a Naive Bayes model, a Stochastic Gradient Descent (SGD) model, a K Nearest Neighbor (KNN) model, a Light Gradient Boosting Machine (GBM) model, an eXtreme Gradient (XG) Boosting model. The set of classification models 104-12 may include mechanisms such as, for example, Logistic Regressor, Random Forest, Decision Tree, SVM, Naive Bayes, SGD, KNN, and Light GBM.

In an embodiment, while using any of the above mentioned models by the set of classification models 104-12, respective parameters for a model may be tuned using the hyper-parameter tuning block 104-14. Similarly, parameters of the mechanisms of the set of classification models 104-12 may be tuned using the hyper-parameter tuning block 104-14. To train and achieve a well performing machine learning model, the hyper-parameter tuning block 104-14 may tune parameters to fit in a particular use case for which the dataset has been received.

In some embodiment, during the cognitive cycle a set of training input data and mis-classified data or data with low confidence prediction may be fed to the machine learning model. If during a first instance, a decision tree model may have been determined as a best model for a particular set of data, then in a second iteration when the machine learning model is being re-trained, the decision tree model may not produce expected higher quality results as in the earlier instance. In such a case, the model that performs higher than expected during the second instance may be selected and the selected model may replace the decision tree model. This process of determining a performance of each of the model and replacing the earlier determined model when a higher performance is known may be performed repeatedly.

As may be appreciated, for training the machine learning model, there may be no restriction that the model once selected may be used permanently and may be replaced with a higher performing model. In addition, the models may be ranked and arranged accordingly for being selected during a selection phase.

In an embodiment, after using either of the regression models or the classification models, performance of each of generated machine learning model using a particular tuning model may be determined. The determined machine leaning model may then be ranked based on decision by the data analyst. For example, if the data analyst decides to preserve and maintain top five models then an instruction to save top five models may be generated.

Further, the top models may be ranked and preserve. In addition, features and tuning parameters of the ranked models may be maintained for future use in the saved model and features used block 104-16. As may be appreciated, the saved model may be saved in any of a pickle format, a h5 format, a hdf5 format, and the like. This block may be maintaining results related to the determined machine leaning model in a track mode and maintain steps of how the model was trained.

Additionally, the reports created at block 104-8 may be sent to the load trained model and predict block 104-18 for predicting the model to be used.

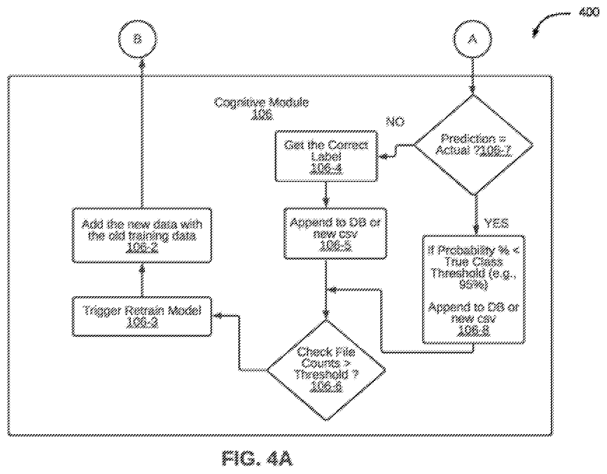

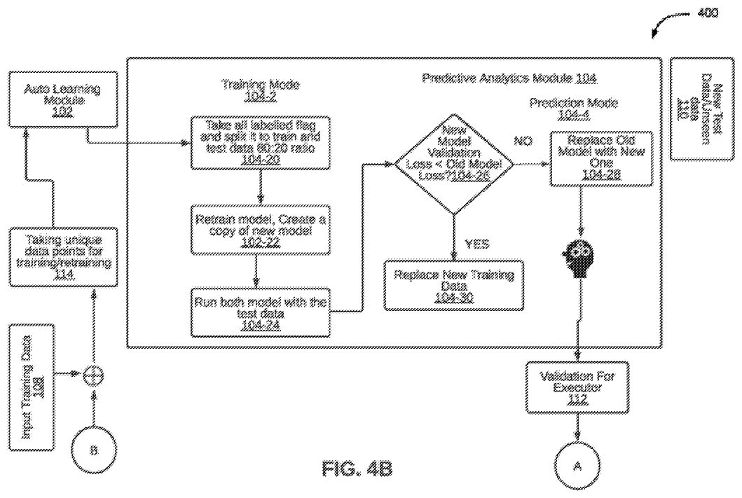

Referring now to FIGS. 4A-4B, a block diagram of the system 400 (corresponding to system 100) for optimizing training of a machine learning model is illustrated, in accordance with yet another embodiment of the present disclosure. The system 400 may include the cognitive module 106 for validating the set of relevant training data samples is illustrated, in accordance with some embodiments of the present disclosure. The cognitive module 106 may be executed based on records validated by the executor for identifying the entries which are critical to be learned by the model. The entries may be saved and passed to the auto-learning module 102 when required. The cognitive module 106 works on a principle of not taking all data points for retraining purposes and taking data points where training confidence level is less or where training confidence has been given an incorrect value.

Upon receiving a validation from an executor at the validation by executor block 112, a cognitive module 106 may predict on test data. The system 100 may not be aware of whether the prediction related to data points that has been received is correct. Therefore, for a particular classification probe once the validator validates the received data, the data analyst may receive the information for data points corresponding the data and compare it with predicted data points at 107-7.

For all the data points, it may be determined what are the actual determined values and what values may have been predicted by the machine learning model. In case, if for a particular classification the determined data points are correct then a prediction probability, at 106-8, for that particular class may be determined and maintained at a database. Further, it may be determined if the machine learning model is able to predict the class with a higher level of probability i.e., if the machine learning model may determine that the data lies in a particular class. In case the machine learning model is able to determine that the data lies within a correct class, then it may be concluded that the machine learning model has learned well for a sample of data points and so this sample of the data points may not be needed for training or re-training the machine learning model.

When the prediction is incorrect, (i.e., received with 60% confidence) at 106-7, it may be determined that the machine learning model has a low prediction probability. As may be appreciated, to regain confidence of the machine learning model, the sample of data points may be reused for training the machine learning model. Additionally, the data point with a current label may be preserved to be used for future learning. However, if the data point is incorrect, it may be concluded that the machine learning model did not learn well for that data point and that data point may not be considered for training purposes. Further, the data point may be labelled with a correct value at 106-4 so that the data point may learn on the current label.

Additionally, determined sample data points may be maintained in a database at 106-5 which may be used for retraining the machine learning model. The cognitive block will collect all data points that are incorrectly classified and the data points with low confidence but with a correct class. Once appending and correcting of the data points is concluded, a trigger to retrain the machine learning model at 106-3 may be generated. The earlier determined training data may be appended to existing training data at 106-2. As may be appreciated, as we cannot train the machine learning model for each of determined input data, so after a batch of execution a set of correct samples or cases may be selected to retrain the machine learning model. Parallelly a check on whether an input data point is giving correct results may be maintained. Output from 106-2 may sent as input and combined with the input training data 108. Further, unique data points for the training/retraining of the machine learning model may be determined at 114.

All shortcomings of the new machine learning model may be determined and all labelled flags may be determined by analyzing a received input from the auto learning module 102. At 104-20, the data samples that existed earlier and new test data recovered from a new machine learning model may be compared. This may reduce the data samples that may be required for checking if a trained machine learning model works accurately or the new machine learning model may work more efficiently than an existing trained model.

For comparing the earlier trained machine learning model and the new created model, exiting training data may be split into a predetermined ratio, for example 80:20 where 80% of the data samples may be reiterated for the newly created model or 20% data may be checked for performance of the trained machine learning model. This may enable the existing model to be evaluated in entirety as per the data samples and not replaced by the newly created model unnecessarily.

The earlier trained machine learning model may be preserved, and a copy of the new machine learning model may be created at 102-22. Using these flags, the new machine learning model may be split to test and train the data points. For the same, the machine learning model that is already trained may receive more valid data and the earlier trained machine learning model and the new machine learning model may be run using the determined input data points at 104-24.

If validation loss of the new machine learning model is less than the existing trained model at 104-26, then new training data may be replaced at 104-30. Else, the existing trained machine learning model may be replaced with the new machine learning model at 104-28 that may be validated by the executor.

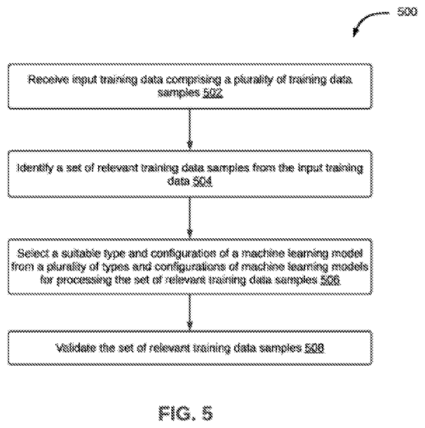

Referring now to FIG. 5, a flowchart of a method 500 of optimizing training of a machine learning model is illustrated, in accordance with an embodiment. At step 502, input training data including a plurality of training data samples may be received.

At step 504, a set of relevant training data samples may be identified from the input training data. In some embodiments, the identifying the set of relevant training data samples from the input training data may include identifying a plurality of features from the input training data, selecting a set of relevant features from the plurality of features, generating one or more clusters from the selected set of relevant features based on one or more distance-based techniques, ranking the generated one or more clusters, determining a sample selection number from the ranked one or more clusters and creating a sample arrangement, selecting a sample from the created sample arrangement, and creating a reduced dataset from the selected sample.

At step 506, a suitable type and configuration of a machine learning model may be selected from a plurality of types and configurations of machine learning models for processing the set of relevant training data samples. Features may be selected and extracted from the type and configuration of the machine learning model. In some embodiments, selecting a suitable type and configuration of machine learning model may include monitoring performance of each of the plurality of types and configurations of machine learning models with the set of relevant training data samples, ranking each of the plurality of types and configurations of machine learning models in relation to the set of relevant training data samples, based on the performance, and selecting the suitable type and configuration of machine learning model from the plurality of types and configurations of the machine learning models, based on the ranking. For example, the monitoring may be based on the prediction of each ML Model on the validation data, i.e. based on the performance of the each of the ML models during the training phase.

In some embodiments, selecting the suitable type and configuration of a machine learning model may further include pre-processing the set of relevant training data samples. The pre-processing may include at least one of: imputing missing values, removing outlier values, handling categorical variable values, removing duplicate data samples, or correcting inconsistent data samples.

At step 508, the set of relevant training data samples may be validated. In some embodiments, validating the set of relevant training data samples may include obtaining, from the suitable type and configuration of machine learning model, a prediction and an accuracy probability score associated with the prediction, comparing the accuracy probability score with a threshold score, and validating the set of relevant training data samples based on the comparison. The probability scoring may be done using any of a Mean square error (MSE), a Root mean square error (RMSE) for regressor and a F1 score, accuracy, precision, recall for classification models.

One or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It will be appreciated that, for clarity purposes, the above description has described embodiments of the disclosure with reference to different functional units and processors. However, it will be apparent that any suitable distribution of functionality between different functional units, processors or domains may be used without detracting from the disclosure. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present disclosure has been described in connection with some embodiments, it is not intended to be limited to the specific form set forth herein. Rather, the scope of the present disclosure is limited only by the claims. Additionally, although a feature may appear to be described in connection with particular embodiments, one skilled in the art would recognize that various features of the described embodiments may be combined in accordance with the disclosure.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

We claim:

1. A method of optimizing training of a machine learning model, the method comprising: receiving, by an optimization device, input training data comprising a plurality of training data samples;
identifying, by the optimization device, a set of relevant training data samples from the input training data;
selecting, by the optimization device, a suitable type and configuration of a machine learning model from a plurality of types and configurations of machine learning models for processing the set of relevant training data samples; and
validating the set of relevant training data samples.

2. The method as claimed in claim 1, wherein identifying the set of relevant training data samples from the input training data comprises at least one of:
identifying a plurality of features from the input training data;
selecting a set of relevant features from the plurality of features;
generating one or more clusters from the selected set of relevant features based on one or more distance-based techniques;
ranking the generated one or more clusters;
determining a sample selection number from the ranked one or more clusters and creating a sample arrangement;
selecting a sample from the created sample arrangement; and creating a reduced dataset from the selected sample.

3. The method as claimed in claim 1, wherein selecting a suitable type and configuration of machine learning model comprises:
monitoring performance of each of the plurality of types and configurations of machine learning models with the set of relevant training data samples;
ranking each of the plurality of types and configurations of machine learning models in relation to the set of relevant training data samples, based on the performance; and
selecting the suitable type and configuration of machine learning model from the plurality of types and configurations of the machine learning models, based on the ranking.

4. The method as claimed in 3, wherein selecting the suitable type and configuration of a machine learning model further comprises pre-processing the set of relevant training data samples, wherein the pre-processing comprises at least one of:
imputing missing values; removing
outlier values;
handling categorical variable values; removing
duplicate data samples; and
correcting inconsistent data samples.

5. The method as claimed in claim 1, wherein validating the set of relevant training data samples comprises:
obtaining, from the suitable type and configuration of machine learning model, a prediction and an accuracy probability score associated with the prediction;
comparing the accuracy probability score with a threshold score; and
validating the set of relevant training data samples based on the comparison.

6. A system, comprising:
one or more computing devices configured to:
receive, by an input module, input training data comprising a plurality of training data samples;
determining, by the auto-learning module, a set of relevant training data samples from the input training data,
selecting, by the predictive analysis module, a suitable type and configuration of a machine learning model from a plurality of types and configurations of machine learning models for processing the set of relevant training data samples; and
validating, by the executor, the set of relevant training data samples.

7. The system as recited in claim 6, wherein determining a right set of features for training the machine learning model is based at least in part of:
identifying a plurality of features from the input training data; selecting
a set of relevant features from the plurality of features;
generating one or more clusters from the selected set of relevant features based on one or more distance-based techniques;
ranking the generated one or more clusters;
determining a sample selection number from the ranked one or more clusters and creating a sample arrangement;
selecting a sample from the created sample arrangement; and
creating a reduced dataset from the selected sample.

8. The system as recited in claim 6, wherein selecting a suitable type and configuration of machine learning model comprises:
monitoring performance of each of the plurality of types and configurations of machine learning models with the set of relevant training data samples;
ranking each of the plurality of types and configurations of machine learning models in relation to the set of relevant training data samples, based on the performance; and
selecting the suitable type and configuration of machine learning model from the plurality of types and configurations of the machine learning models, based on the ranking.

9. The system as recited in 8, wherein selecting the suitable type and configuration of a machine learning model further comprises pre-processing the set of relevant training data samples, wherein the pre-processing comprises at least one of:
imputing missing values;
removing outlier values;
handling categorical variable values;
removing duplicate data samples; and
correcting inconsistent data samples.

10. The system as recited in 1, wherein validating the set of relevant training data samples comprises:
obtaining, from the suitable type and configuration of machine learning model, a prediction and an accuracy probability score associated with the prediction; comparing the accuracy probability score with a threshold score; and
validating the set of relevant training data samples based on the comparison.
